(19) United States
(12) Patent Application Publication
(10) Pub. No.: US 2021/0041263 A1
(43) Pub. Date: Feb. 11, 2021

(54) MAP INFORMATION UPDATING SYSTEM AND MAP INFORMATION UPDATING PROGRAM

(71) Applicant: AISIN AW CO., LTD., Anjo-shi, Aichi-ken (JP)

(72) Inventors: Morihiro HIRATE, Okazaki (JP); Sadahiro KOSHIBA, Takahama (JP)

(73) Assignee: AISIN AW CO., LTD., Anjo-shi, Aichi-ken (JP)

(21) Appl. No.: 16/977,254

(22) PCT Filed: Apr. 10, 2019
(86) PCT No.: PCT/JP2019/015572

§ 371 Date: Sep. 1, 2020

(30) Foreign Application Priority Data
Apr. 18, 2018 (JP) 2018-080111

(51) Int. Cl. G01C 21/00; G06F 16/29; G06F 16/23; G06K 9/00; G06K 9/46

(52) U.S. Cl. CPC G01C 21/3815; G06F 16/29; G06K 9/4652; G06K 9/00798; G06K 9/4604; G06F 16/2379

(57) ABSTRACT

A technique for increasing the possibility that a lane structure indicated by map information can be updated to map information that corresponds to reality. A map information updating system includes an image lane structure obtaining part that obtains an image lane structure based on an image of an area around a vehicle, the image lane structure being a lane structure of a road on which the vehicle is present; a map lane structure obtaining part that obtains a map lane structure which is a lane structure of the road indicated by map information; and a map information updating part that determines whether the image lane structure matches the map lane structure, and updates the map information with the image lane structure when the image lane structure does not match the map lane structure, the map information indicating the lane structure of the road.

### TECHNICAL FIELD

The disclosure relates to a map information updating system and a map information updating program.

### BACKGROUND ART

Conventionally, there is known a technique for updating map information in the course of using the map information. For example, Patent Literature 1 discloses a technique for estimating the presence of a lane on which a vehicle is not traveling, by detecting a lane change made by the vehicle.

### CITATIONS LIST

### Patent Literature

Patent Literature 1: JP 2007-241470 A

### SUMMARY

### Technical Problems

In the conventional technique, unless a lane change is detected, the presence of a lane on which the vehicle is not traveling cannot be estimated.

The disclosure is made in view of the above-described problem, and provides a technique for increasing the possibility that a lane structure indicated by map information can be updated to map information that corresponds to reality.

### Solutions to Problems

To provide the above-described technique, a map information updating system includes: an image lane structure obtaining part that obtains an image lane structure based on an image of an area around a vehicle, the image lane structure being a lane structure of a road on which the vehicle is present; a map lane structure obtaining part that obtains a map lane structure, the map lane structure being a lane structure of the road indicated by map information; and a map information updating part that determines whether the image lane structure matches the map lane structure, and updates the map information with the image lane structure when the image lane structure does not match the map lane structure, the map information indicating the lane structure of the road.

In addition, to provide the above-described technique, a map information updating program causes a computer to function as: an image lane structure obtaining part that obtains an image lane structure based on an image of an area around a vehicle, the image lane structure being a lane structure of a road on which the vehicle is present; a map lane structure obtaining part that obtains a map lane structure, the map lane structure being a lane structure of the road indicated by map information; and a map information updating part that determines whether the image lane structure matches the map lane structure, and updates the map information with the image lane structure when the image lane structure does not match the map lane structure, the map information indicating the lane structure of the road.

Namely, in the map information updating system and the map information updating program, an image lane structure is obtained based on an image of an area around the vehicle, and when the image lane structure differs from a map lane structure indicated by map information, the map information is updated with the image lane structure. Therefore, map information that defines a lane structure can be generated based on an actual image of an area around the vehicle. Hence, the possibility that a lane structure indicated by map information can be updated to map information that corresponds to reality can be increased.

### BRIEF DESCRIPTION OF DRAWINGS

FIG. 1 is a block diagram of a navigation system.

FIGS. 2A and 2B are diagrams showing examples of a road section, map lane structures, and image lane structures.

FIGS. 3A and 3B are diagrams showing examples of a road section, map lane structures, and image lane structures.

FIGS. 4A and 4B are diagrams showing examples of a road section, map lane structures, and image lane structures.

FIG. 5 is a flowchart of a map information update process.

### DESCRIPTION OF EMBODIMENTS

Here, embodiments of the disclosure will be described in the following order:

(1) Configuration of a navigation system;

(2) Map information update process; and

(3) Other embodiments.

### (1) Configuration of a Navigation System

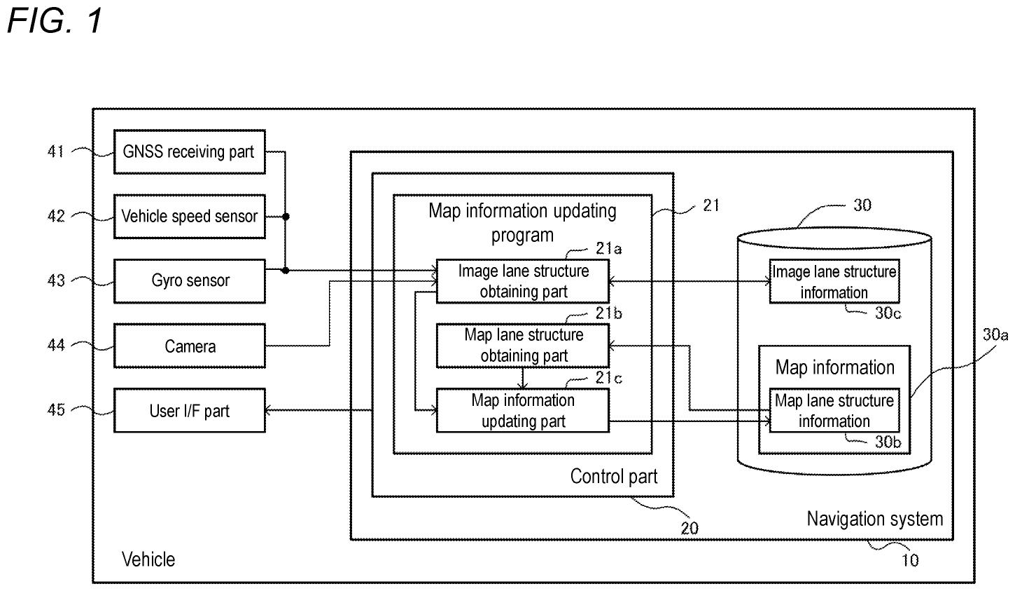

FIG. 1 is a block diagram showing a configuration of a navigation system 10 including a map information updating system according to one embodiment of the disclosure. The navigation system 10 is included in a vehicle, and includes a control part 20 including a CPU, a RAM, a ROM, etc., and a recording medium 30. The navigation system 10 can execute, by the control part 20, programs stored in the recording medium 30 and the ROM. In the recording medium 30, map information 30a is recorded in advance, and image lane structure information 30c is recorded in the course of vehicle travel.

The map information 30a is information used, for example, to identify a vehicle location and a facility which is a guidance target and identify a recommended lane, and includes node data representing the locations of nodes set on roads on which the vehicle travels, etc.; shape interpolation point data representing the locations of shape interpolation points for identifying the shapes of roads between nodes, etc.; link data representing links between nodes; data representing the locations of ground objects present on roads or around the roads; and the like.

In addition, in the present embodiment, the link data is defined for each traveling direction of the vehicle on a road section, and is associated with the traveling direction. Hence, for a two-way traffic road, one link is defined for each direction. Furthermore, in the present embodiment, link data is associated with information indicating a lane structure of lanes on a road which is represented by the link data. Link data indicates a one-way traffic road and also indicates a two-way traffic road. In the case of a two-way traffic road, link data is associated with information indicating a lane structure of lanes on a road which is represented by the link data, such that the information is distinguishable between traveling directions. Here, information indicating a lane structure and included in the map information 30a is called map lane structure information 30b.

The map lane structure information 30b is information indicating a lane structure present on a road. The information indicating a lane structure can be defined in various ways, but in the present embodiment, the information includes information indicating a point of change at which a lane structure changes, the number of lanes on a road, the types of lane borders on the road, the colors of the lane borders on the road, and the widths of the lanes on the road.

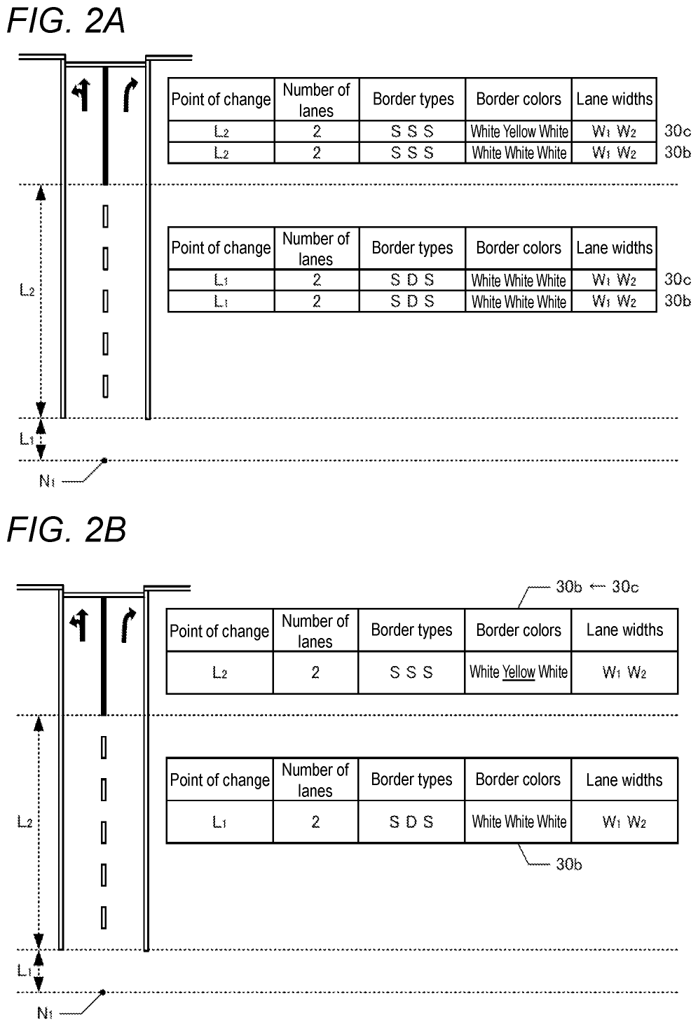

FIG. 2B is a diagram showing an example of map lane structure information 30b. In FIG. 2B, a road section extending from a node N₁ is exemplified on the left, and pieces of information indicating lane structures of the road section are exemplified in tables shown on the right. In the present embodiment, a point at which at least one of the number of lanes on a road, the types of lane borders on the road, the colors of the lane borders on the road, and the widths of the lanes on the road changes on the road is defined as a point of change.

In the present embodiment, a point of change is represented by a distance from a node corresponding to a starting point (a rear end point in a traveling direction) of a road section. For example, in the example shown in FIG. 2B, the border type of a border present in the middle of a portion of the road section on a rear side in a traveling direction of the road section is a dashed line, but the border type of a border present in the middle of a portion of the road section on a front side is a solid line. Therefore, a point at which the border type changes from the dashed line to the solid line is a point of change. In the example shown in FIG. 2B, the point of change is present at a point at a distance L₂ from the node N₁.

In addition, in front of the point of change, the number of lanes is two, the types of borders are all solid lines, the colors of the borders are yellow for the middle border (in FIG. 2B, yellow paint is represented in black; the same also applies to other drawings) and white for the left and right borders, and the widths of the lanes are W₁ and W₂ in order from the left. In the present embodiment, a point of change is associated with a lane structure present on a front side in a traveling direction of the point of change. Therefore, as shown in FIG. 2B, by associating the point of change represented by the distance L₂ from the node N₁ with the number of lanes: two, the types of borders: S, S, and S (S indicates a solid line: the same also applies to the following), the border colors: white, yellow, and white, and the lane widths: W₁ and W₂, a lane structure is defined.

Likewise, in front of the node N₁, at a distance L₁ from the node N₁, lanes appear on the road section after passing through an intersection. Hence, for the lane structure, as shown in FIG. 2B, by associating the distance L₁ from the node N₁, the number of lanes: two, the types of borders: S, D, and S (D indicates a dashed line: the same also applies to the following), the border colors: white, yellow, and white, and the lane widths: W₁ and W₂ with each other, a lane structure is defined. Information indicating a lane structure on a road is defined in advance, and is included as map lane structure information 30b in the map information 30a.

In the present embodiment, a point of change at which a lane structure changes, the number of lanes on a road, the types of lane borders on the road, the colors of the lane borders on the road, and the widths of the lanes on the road are called a plurality of elements indicating a lane structure. The plurality of elements can serve as an update target in information indicating the lane structure. Map lane structure information 30b is associated with a traveling direction that can be selected in each lane. For example, when given link data represents a road entering a given node, three lanes are present on the road entering an intersection at which the given node is present, and straight ahead and a left turn are allowed for a left lane, straight ahead is allowed for a middle lane, and a right turn is allowed for a right lane, information indicating them is included in map lane structure information 30b. Here, description is made assuming that a traveling direction that can be selected in each lane is not an update target, but of course, the traveling direction may be an update target.

The vehicle of the present embodiment includes a GNSS receiving part 41, a vehicle speed sensor 42, a gyro sensor 43, a camera 44, and a user I/F part 45. The GNSS receiving part 41 is a device that receives Global Navigation Satellite System signals, and receives radio waves from navigation satellites and outputs a signal for calculating a current location of the vehicle through an interface which is not shown. The control part 20 obtains the signal and thereby obtains a current location of the vehicle. The vehicle speed sensor 42 outputs a signal corresponding to the rotational speed of wheels included in the vehicle. The control part 20 obtains the signal through an interface which is not shown, and thereby obtains vehicle speed. The gyro sensor 43 detects angular acceleration of the vehicle for a turn in a horizontal plane, and outputs a signal corresponding to the orientation of the vehicle. The control part 20 obtains the signal and thereby obtains a traveling direction of the vehicle. The vehicle speed sensor 42, the gyro sensor 43, and the like, are used to identify a travel path of the vehicle. In the present embodiment, a current location is identified based on the point of departure and travel path of the vehicle, and the current location of the vehicle identified based on the point of departure and the travel path is corrected based on the output signal from the GNSS receiving part 41.

The camera 44 is a camera fixed to the vehicle such that its field of view includes lanes on a road on which the vehicle travels, and photographs an image in a predetermined cycle, and generates and outputs image information indicating the photographed image. The control part 20 obtains the image information outputted from the camera 44.

The user I/F part 45 is an interface part for accepting, as input, instructions from a driver and providing various types of information to the driver, and includes a touch panel display, switches, etc., a speaker, etc., which are not shown. Namely, the user I/F part 45 includes an output part for images and audio and an input part for instructions provided by the driver.

The control part 20 can perform a function of guiding the vehicle to a destination along a planned travel route by a function of a navigation program which is not shown. Upon performing a navigation function, the control part 20 accepts input of a destination performed by the driver through the input part (buttons, a touch panel, etc.) of the user I/F part 45 which is not shown, by the function of the navigation program. In addition, the control part 20 obtains a current location of the vehicle based on output signals from the GNSS receiving part 41, the vehicle speed sensor 42, and the gyro sensor 43. Then, the control part 20 searches for a route for traveling to the destination with the current location being a point of departure, by referring to the map information 30a, and obtains the route as a planned travel route.

When vehicle travel starts with the planned travel route identified, by the function of the navigation program, the control part 20 identifies a current location every certain period, based on output signals from the GNSS receiving part 41, the vehicle speed sensor 42, and the gyro sensor 43. Then, the control part 20 outputs a control signal to the output part (the display, the speaker, etc.) of the user I/F part 45, and provides route guidance so that the current location can move along the planned travel route.

Note that in the present embodiment, by the navigation program, the control part 20 performs a function of obtaining a recommended lane for traveling along the planned travel route based on map lane structure information 30b, and providing guidance on the recommended lane. Namely, the control part 20 obtains an intersection passing through upon traveling along the planned travel route, and obtains an entry direction to the intersection and an exit direction from the intersection. Then, based on map lane structure information 30b, the control part 20 identifies a lane to be selected upon traveling in the exit direction from the entry direction, as a recommended lane. In the course of route guidance, the control part 20 outputs a control signal to the output part (the display, the speaker, etc.) of the user I/F part 45, and thereby provides guidance on the recommended lane.

The navigation program includes a function of updating map information, in addition to such a route guidance function. The function of updating map information is implemented by a map information updating program 21. The map information updating program 21 includes an image lane structure obtaining part 21a, a map lane structure obtaining part 21b, and a map information updating part 21c.

The image lane structure obtaining part 21a is a program module that allows the control part 20 to perform a function of obtaining an image lane structure which is a lane structure of a road on which the vehicle is present, based on an image of an area around the vehicle. Namely, by the function of the image lane structure obtaining part 21a, the control part 20 obtains an image from the camera 44 every certain period, and obtains a lane structure based on the image. In addition, the control part 20 performs an image recognition process on the image obtained by the camera 44, and thereby identifies a lane structure of lanes around the vehicle.

For the image recognition, various techniques that can identify a lane structure may be adopted. For example, it is possible to adopt a process of identifying the number of lanes by identifying the number of borders by performing an analysis to obtain features of lane borders from an image, a process of identifying border types by identifying the shapes of borders, a process of identifying border colors by identifying the color components of borders, or a process of identifying lane widths by identifying a distance between borders. Note that in the present embodiment a lane structure obtained based on an image photographed by the camera 44 is called an image lane structure.

In the course of obtaining an image lane structure, the control part 20 also parallelly performs a process of identifying a current location of the vehicle, based on output signals from the GNSS receiving part 41, the vehicle speed sensor 42, and the gyro sensor 43. When the latest image lane structure obtained differs from its immediately preceding image lane structure, the control part 20 associates the latest image lane structure with the current location, and records the latest image lane structure as image lane structure information 30c in the recording medium 30.

The map lane structure obtaining part 21b is a program module that allows the control part 20 to perform a function of obtaining a map lane structure which is a lane structure of a road indicated by map information. In the present embodiment, image lane structure information 30c is obtained during traveling, and when the image lane structure information 30c differs from map lane structure information 30b, the map lane structure information 30b is updated. To do so, the control part 20 identifies a road section on which the vehicle is traveling, based on a current location of the vehicle based on output signals from the GNSS receiving part 41, the vehicle speed sensor 42, and the gyro sensor 43, and the map information 30a. Then, by the function of the map lane structure obtaining part 21b, the control part 20 obtains map lane structure information 30b for the road section on which the vehicle is traveling, by referring to the recording medium 30. Furthermore, the control part 20 extracts, from among the obtained map lane structure information 30b, information whose point of change is present within a predefined area from and closest to a point of change of an image lane structure, as a comparison target.

The map information updating part 21c is a program module that allows the control part 20 to perform a function of determining whether the image lane structure matches the map lane structure, and updating, when the structures do not match each other, the map information indicating the lane structure of the road with the image lane structure. In the present embodiment, the control part 20 determines whether the image lane structure matches the map lane structure by making a comparison for a plurality of elements indicating a lane structure. Namely, in the present embodiment, the control part 20 compares a plurality of elements indicating the image lane structure with a plurality of elements indicating the map lane structure, and if even a single element differs therebetween, the control part 20 determines that the image lane structure does not match the map lane structure.

When the image lane structure does not match the map lane structure, the control part 20 updates the map information indicating the lane structure of the road with the image lane structure. Namely, when map information 30a is prepared in advance, since an extremely large amount of information about roads and lane structures of the roads is prepared, the information may include errors occasionally. In addition, there is also a case in which after providing the map information 30a, roads are changed due to building of a new road, repairing of a road, etc. Therefore, the map lane structure information 30b included in the map information 30a may not be correct.

On the other hand, an image photographed by the camera 44 in the course of the vehicle traveling on a road section includes an image of the latest lanes. Therefore, when image lane structure information 30c differs from map lane structure information 30b, it is highly likely that the image lane structure information 30c shows an actual road structure. Hence, in the present embodiment, the control part 20 updates the map lane structure information 30b with the image lane structure information 30c.

Note that in the present embodiment the control part 20 updates a lane structure in front of a point of change at which a lane structure changes, by changing the lane structure from a lane structure indicated by map lane structure information 30b to a lane structure indicated by image lane structure information 30c. According to this configuration, it is possible to update a lane structure of a portion of a road section present in front of the vehicle, and it is also possible to use updated map lane structure information 30b (e.g., to use the updated map lane structure information 30b for providing guidance on a recommended lane) after the update.

In the present embodiment described above, the control part 20 obtains image lane structure information 30c based on an image of an area around the vehicle which is obtained by the camera 44. Then, when the image lane structure information 30c differs from map lane structure information 30b, the control part 20 updates map information with the image lane structure information 30c. Therefore, in the present embodiment, map information 30a that defines a lane structure can be generated based on an actual image of an area around the vehicle. Hence, the possibility that a lane structure indicated by map information 30a can be updated to map information 30a that corresponds to reality can be increased.

### (2) Map Information Update Process

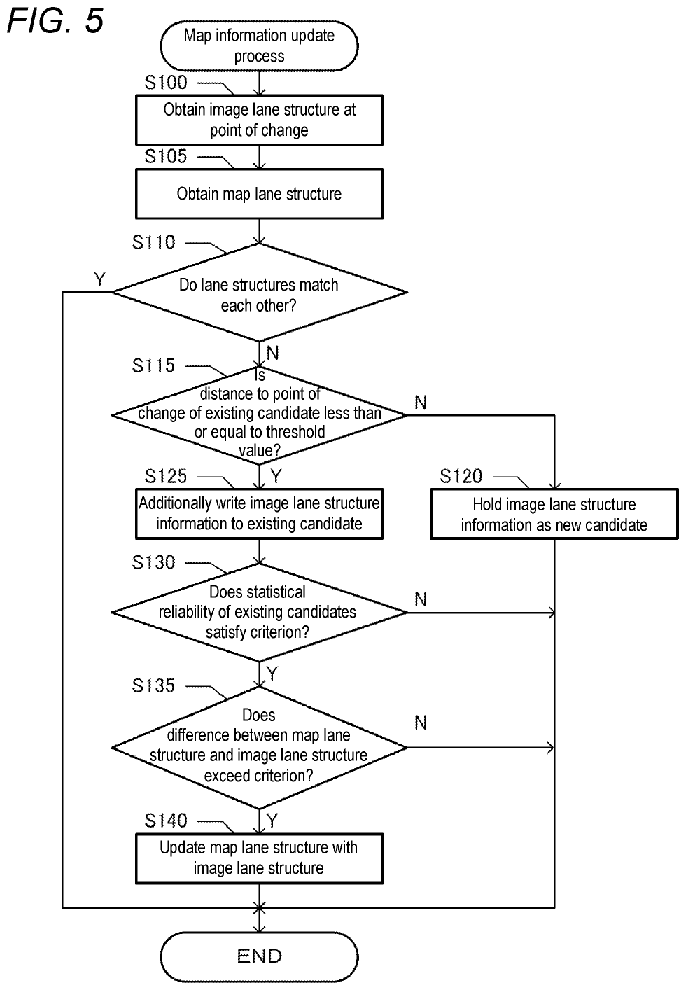

Next, a map information update process performed by the map information updating program 21 will be described. FIG. 5 is a flowchart showing a map information update process performed by the control part 20 using the map information updating program 21. During vehicle travel, the control part 20 starts performance of a map information update process every certain period (e.g., every 100 ms). When, after starting a map information update process, the process does not end within a certain period, the control part 20 waits for the process to end. When a certain period has elapsed from the end of the process, the control part 20 starts a map information update process again.

When a map information update process starts, by the function of the image lane structure obtaining part 21a, the control part 20 obtains an image lane structure at a point of change (step S100). Namely, the control part 20 performs an image recognition process on an image outputted from the camera 44, and thereby identifies a lane structure of lanes around the vehicle. Specifically, the control part 20 identifies the number of lanes on a road section which is photographed as an image, the border types of the lanes, the border colors of the lanes, and lane widths as an image lane structure. The control part 20 records the identified image lane structure in the RAM which is not shown.

Furthermore, the control part 20 compares the latest image lane structure with an image lane structure which is recorded in the RAM immediately before the latest image lane structure is identified, by referring to the RAM. When the structures differ from each other, the control part 20 considers that a current location is a point of change of the lane structure. When the current location is a point of change of the lane structure, the control part 20 identifies a current location of the vehicle based on output signals from the GNSS receiving part 41, the vehicle speed sensor 42, and the gyro sensor 43, and associates the image lane structure with the current location as a point of change. The thus obtained image lane structure is recorded as image lane structure information 30c in the recording medium 30.

FIG. 2A shows examples of image lane structure information 30c and map lane structure information 30b for a road shown on the left. The road shown in FIG. 2A is such that a road section in front of a node N₁ is a four-lane road section, and there are a two-lane road section in front of a point at a distance L₁ from the node N₁. In the road section, the types of borders are a solid line, a dashed line, and a solid line from the left, and the colors of the borders are all white. In addition, the lane widths are W₁ and W₂ from the left. In this example, based on an image obtained by the camera 44 at the point at the distance L₁ from the node N₁, the control part 20 identifies that the lane structure has changed, and obtains the point of change “L₁”, the number of lanes “2”, the border types “S, D, and S”, the border colors “white, white, and white”, and the lane widths “W₁ and W₂” as image lane structure information 30c.

In the example shown in FIG. 2A, the lane structure changes in front of a point at a distance L₂ from the node N₁. Namely, in front of the point, a border present in the middle of the road changes from the dashed line to a solid line and from white to yellow. Hence, based on an image obtained by the camera 44 at the point at the distance L₂ from the node N₁, the control part 20 identifies that the lane structure has changed, and obtains the point of change “L₂”, the number of lanes “2”, the border types “S, S, and S”, the border colors “white, yellow, and white”, and the lane widths “W₁ and W₂” as image lane structure information 30c.

Then, by the function of the map lane structure obtaining part 21b, the control part 20 obtains a map lane structure (step S105). Namely, based on the current location of the vehicle and the map information 30a, the control part 20 identifies a road section on which the vehicle is traveling. Then, the control part 20 obtains map lane structure information 30b for the road section on which the vehicle is traveling, by referring to the recording medium 30. Furthermore, the control part 20 extracts, from among the obtained map lane structure information 30b, information whose point of change is present within a predefined area from and closest to the point of change of the image lane structure which is obtained at step S100.

In FIG. 2A, map lane structure information 30b is exemplified on the right side of the road section. In this example, when the point of change of the image lane structure obtained at step S100 is the point at the distance L₂ from the node N₁, the control part 20 obtains map lane structure information 30b whose point of change is the point at the distance L₂ from the node N₁. Note that, as shown in FIG. 2A, in map lane structure information 30b for a portion of the road section in front of the point at the distance L₂ from the node N₁, the border colors are all white and differ from the actual border colors which are white, yellow, and white. Therefore, in the example shown in FIG. 2A, the map lane structure information 30b for the portion in front of the point at the distance L₂ from the node N₁ is incorrect.

When the map lane structure is obtained, by the function of the map information updating part 21c, the control part 20 determines whether the lane structures match each other (step S110). Namely, the control part 20 compares the image lane structure information 30c obtained at step S100 with the map lane structure information 30b obtained at step S105. In the comparison, the control part 20 makes a comparison for each of a plurality of elements indicating the lane structure, and when there is even a single unmatched element, the control part 20 determines that the lane structures do not match each other.

Note that when a comparison is made for the plurality of elements, the order of comparison is not limited, but in the present embodiment, a determination as to whether the numbers of lanes match each other is made first. Namely, when the numbers of lanes do not match each other, the number of lanes increases or decreases before and after update, and thus, elements other than the number of lanes (border types, border colors, and lane widths) also change. Hence, it can be considered that when it is determined that the numbers of lanes do not match each other, without even making a comparison for the elements other than the number of lanes, these elements are updated (at least added). Therefore, a comparison for the elements other than the number of lanes can be omitted.

TABLE 1

| | | | | Elements other than |
|---|---|---|---|---|
| | | | Number of lanes | number of lanes |
| Map lane structure information is not available | | | Newly register | Newly register |
| Map lane | Numbers of | Elements other than | — | — |
| structure | lanes match | number of lanes match | | |
| information is | each other | Elements other than number | — | Update |
| available | | of lanes do not match | | |

| | | |
|---|---|---|
| Numbers of lanes do not match each other | Update | Update |

Table 1 shows whether to perform an update for different states of existing map lane structure information 30b. Table 1 shows elements to be updated based on the state of the map lane structure information 30b. The elements to be updated are shown classified into the number of lanes and elements other than the number of lanes. When map lane structure information 30b is not available, as shown in Table 1, the number of lanes and all elements other than the number of lanes serve as a new registration target.

When, in a case in which map lane structure information 30b is available, the numbers of lanes do not match each other, as described above, both the number of lanes and the elements other than the number of lanes are updated. On the other hand, when, in a case in which map lane structure information 30b is available, the numbers of lanes match each other, the control part 20 makes a comparison for each of the elements other than the number of lanes. Then, when, in a case in which the numbers of lanes match each other, the elements other than the number of lanes also match, an update is not performed. When an element other than the number of lanes does not match, the unmatched element is updated.

In the example shown in FIG. 2A, when a process is performed with the point at the distance L₂ from the node N₁ being a point of change, the control part 20 compares image lane structure information 30c whose point of change is indicated by the distance L₂ from the node N₁ with map lane structure information 30b, and at this time, first, a comparison is made for the number of lanes. In the example shown in FIG. 2A, since the numbers of lanes match each other, the control part 20 further makes a comparison for other elements in turn. For example, a comparison is made in order of the point of change, border types, border colors, and lane widths. Then, the control part 20 determines that the border colors do not match each other and thus the lane structures do not match each other.

If it is determined at step S110 that the lane structures match each other, the control part 20 skips processes at and after step S115 and ends the map information update process. On the other hand, if it is not determined at step S110 that the lane structures match each other, by the function of the map information updating part 21c, the control part 20 determines whether a distance to a point of change of an existing candidate is less than or equal to a threshold value (step S115). Namely, in the present embodiment, when the image lane structure information 30c does not match the map lane structure information 30b, the control part 20 performs an update after verifying that information indicated by the image lane structure information 30c has high statistical reliability. Then, until the control part 20 verifies that the information has high statistical reliability, the control part 20 holds image lane structure information 30c serving as a candidate in the recording medium 30, etc.

When the image lane structure information 30c serving as a candidate is already held, the image lane structure information 30c is called an existing candidate. At step S115, when the existing candidate is present, the control part 20 identifies a point of change of the existing candidate. Then, the control part 20 considers the magnitude of a difference between the point of change of the existing candidate and a point of change indicated by the latest image lane structure information 30c as a distance between the points of change, and determines whether the distance is less than or equal to a predefined threshold value. Note that the threshold value is a value defined in advance as a threshold value for determining whether a plurality of candidates have the same point of change. In addition, when there are a plurality of existing candidates, any one of the plurality of existing candidates may be selected and a comparison for a distance may be made, or a comparison for a distance may be made based on a statistic of the plurality of existing candidates.

If it is not determined at step S115 that the distance to the point of change of the existing candidate is less than or equal to the threshold value, the control part 20 considers the latest image lane structure information 30c as a new candidate and holds the image lane structure information 30c in the recording medium 30, etc. (step S120). In this case, the control part 20 skips processes after step S120 and ends the map information update process.

If it is determined at step S115 that the distance to the point of change of the existing candidate is less than or equal to the threshold value, the control part 20 additionally writes the image lane structure information to the existing candidate (step S125). Namely, the latest image lane structure information 30c is added to the image lane structure information 30c which is recorded as the existing candidate in the recording medium 30, etc., and is recorded.

Then, by the function of the map information updating part 21c, the control part 20 determines whether the statistical reliability of the existing candidates satisfies a criterion (step S130). The statistical reliability of the existing candidates may be identified by various techniques. For example, it is possible to adopt a configuration in which when the number of existing candidates is greater than or equal to a predefined number, it is determined that the statistical reliability satisfies the criterion. If it is not determined at step S130 that the statistical reliability of the existing candidates satisfies the criterion, the control part 20 skips processes at and after step S135 and ends the map information update process.

On the other hand, if it is determined at step S130 that the statistical reliability of the existing candidates satisfies the criterion, by the function of the map information updating part 21c, the control part 20 determines whether a difference between the map lane structure and the image lane structure exceeds a criterion (step S135). Namely, since the control part 20 performs an update when the difference between the map lane structure and the image lane structure is a significant difference that justifies an update, a criterion for determining whether the difference is the significant difference is set in advance.

For example, for elements having the property of not changing continuously (the number of lanes, border types, and border colors), it is possible to adopt, for example, a configuration in which when the number of times that an element indicated by the map lane structure information 30b differs from a corresponding element indicated by the image lane structure information 30c is greater by a certain amount or more than the number of times that they match each other, it is determined that the statistical reliability of the existing candidates satisfies the criterion. In the case of the example shown in FIG. 2A, when the number of times that the border colors: white, yellow, and white is obtained as image lane structure information 30c is greater by a certain amount or more than the number of times that the border colors: white, white, and white is obtained, the control part 20 determines that the statistical reliability of the existing candidates satisfies the criterion. Of course, a configuration may be adopted in which, for example, when a value obtained by dividing the number of times that an element indicated by the map lane structure information 30b differs from a corresponding element indicated by the image lane structure information 30c by the number of times that they match each other exceeds a predefined value, it is determined that the statistical reliability of the existing candidates satisfies the criterion.

In addition, for elements having the property that the elements can change continuously (a point of change and lane widths), it is possible to adopt, for example, a configuration in which when a difference between a value indicated by the map lane structure information 30b and the mode indicated by the image lane structure information 30c is greater than or equal to a threshold value, it is determined that the difference exceeds the criterion. An element whose difference between a map lane structure and an image lane structure is determined to exceed the criterion serves as an update target. Note, however, that in the present embodiment, as described above, when the numbers of lanes do not match each other, without making a comparison for other elements, all elements serve as an update target. Therefore, at step S135, the control part 20 first compares the number of lanes indicated by the map lane structure information 30b with the number of lanes indicated by the image lane structure information 30c, and when a difference between the numbers of lanes exceeds the criterion, all elements serve as an update target. For the other elements, a determination as to whether a difference exceeds the criterion is omitted.

If it is not determined at step S135 that the difference between the map lane structure and the image lane structure exceeds the criterion, the control part 20 skips step S140 and ends the map information update process. On the other hand, if it is determined at step S135 that the difference between the map lane structure and the image lane structure exceeds the criterion, by the function of the map information updating part 21c, the control part 20 updates the map lane structure with the image lane structure (step S140). Namely, for an element that is determined to serve as an update target at step S135, the control part 20 identifies the most probable value based on the pieces of image lane structure information 30c which are the existing candidates.

For example, in the case of a point of change, the control part 20 obtains the mode of the point of change from among the pieces of image lane structure information 30c which are the existing candidates, and overwrites a point of change indicated by the map lane structure information 30b with the mode. In addition, in the case of border colors, the control part 20 obtains modal border colors from among the pieces of image lane structure information 30c which are the existing candidates, and overwrites the map lane structure information 30b with the border colors. For example, in the example shown in FIG. 2A, when modal border colors indicated by the pieces of image lane structure information 30c which are the existing candidates are white, yellow, and white, the control part 20 updates border colors indicated by the map lane structure information 30b with white, yellow, and white. FIG. 2B shows map lane structure information 30b updated in the example shown in FIG. 2A. Note that when map lane structure information 30b having a point of change that is present within the predefined area from and closest to the point of change of the image lane structure which is obtained at step S100 is not identified, the control part 20 considers image lane structure information 30c which is an existing candidate as map lane structure information 30b, and newly registers the image lane structure information 30c.

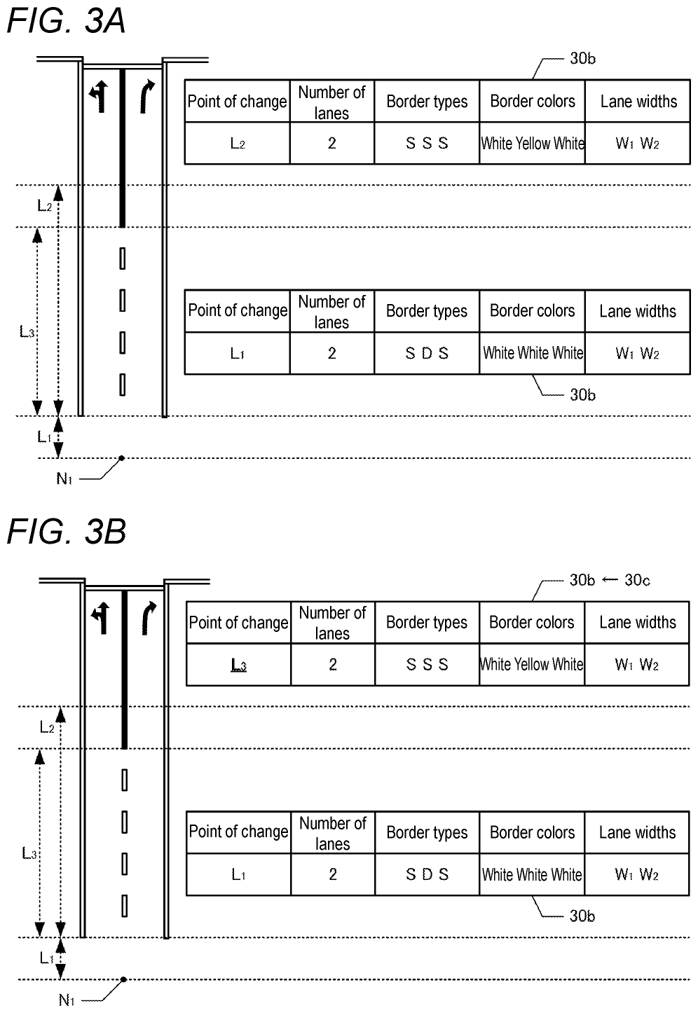

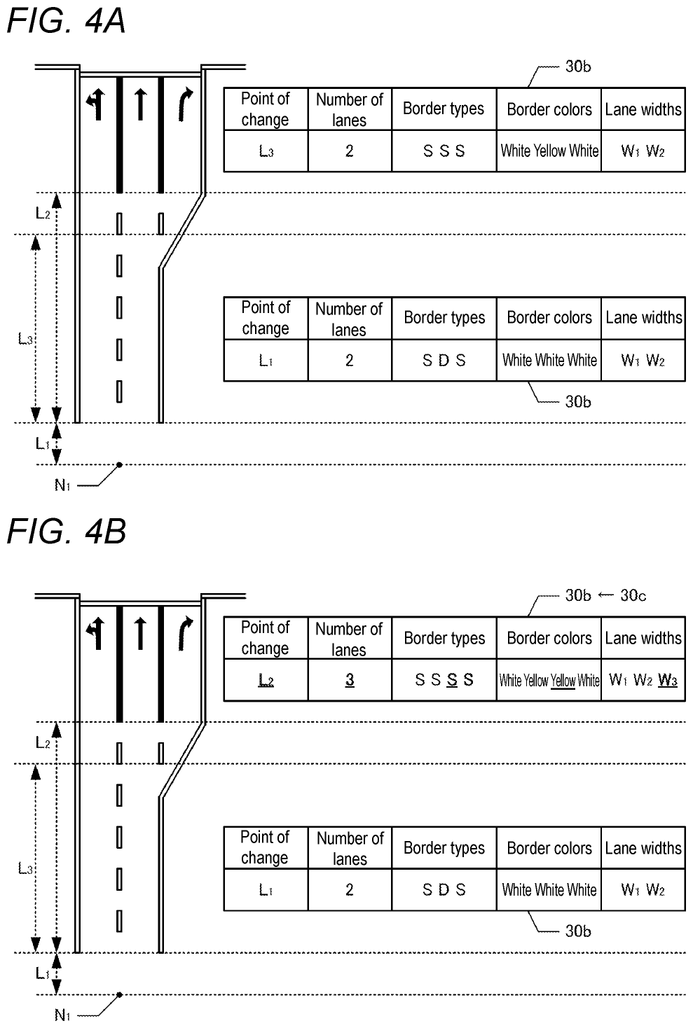

FIGS. 3A to 4B show other examples of an update to map lane structure information 30b. FIGS. 3A and 3B are diagrams describing an update performed when a point of change indicated by map lane structure information 30b differs from an actual point of change. In a road section shown in FIGS. 3A and 3B, points of change are present at points at distances L₁ and L₃ from a node N₁. FIG. 3A shows map lane structure information 30b before update, and map lane structure information 30b whose point of change is a point at the distance L₁ from the node N₁ correctly shows a lane structure of the road section.

On the other hand, in the example shown in FIG. 3A, map lane structure information 30b whose point of change is a point at the distance L₃ from the node N₁ is not available, but instead map lane structure information 30b whose point of change is a point at a distance L₂ from the node N₁ is available. Therefore, the map lane structure information 30b is incorrect. Note that in the map lane structure information 30b whose point of change is the point at the distance L₂ from the node N₁, elements other than the point of change correctly show a lane structure of the road section.

In this example, when a map information update process is performed, at step S100, the control part 20 obtains image lane structure information 30c whose point of change is the point at the distance L₃ from the node N₁. In addition, at step S105, the control part 20 obtains information whose point of change is present within the predefined area from and closest to the point at the distance L₃ from the node N₁, i.e., map lane structure information 30b whose point of change is the point at the distance L₂ from the node N₁.

As a result, at step S110, the control part 20 determines that lane structures do not match each other, and accumulates, at step S120 and S125, pieces of image lane structure information 30c as candidates. Therefore, when the vehicle has traveled the same road a plurality of times and the statistical reliability of existing candidates has satisfied the criterion, the control part 20 performs step S135 after step S130. Then, when a difference between a value indicated by the map lane structure information 30b and the mode indicated by the image lane structure information 30c is greater than or equal to the threshold value, the control part 20 determines that a difference between a map lane structure and an image lane structure exceeds the criterion, and determines that the point of change serves as an update target.

As a result, at step S140, the control part 20 updates the point of change indicated by the map lane structure information 30b with the mode of the point of change. FIG. 3B shows map lane structure information 30b after being updated based on the image lane structure information 30c. Namely, as shown in FIG. 3B, in the map lane structure information 30b after update, the point of change is changed to the point at the distance L₃ from the node N₁.

FIGS. 4A and 4B are diagrams describing an update performed when the number of lanes indicated by map lane structure information 30b differs from the actual number of lanes. In a road section shown in FIGS. 4A and 4B, points of change are present at points at distances L₁ and L₂ from a node N₁ (when the number of lanes changes, a lane width gradually changes, but here a point at which the change of the lane width is completed and a constant lane width is obtained is considered as a point of change). FIG. 4A shows map lane structure information 30b before update, and map lane structure information 30b whose point of change is a point at the distance L₁ from the node N₁ correctly shows a lane structure of the road section.

On the other hand, in the example shown in FIG. 4A, map lane structure information 30b whose point of change is a point at the distance L₂ from the node N₁ is not available, but instead map lane structure information 30b whose point of change is a point at a distance L₃ from the node N₁ is available. In the map lane structure information 30b the number of lanes is two, and in the actual road section the number of lanes is three, and thus, all elements have errors in lane structure.

In this example, when a map information update process is performed, at step S100, the control part 20 obtains image lane structure information 30c whose point of change is the point at the distance L₂ from the node N₁. In addition, at step S105, the control part 20 obtains information whose point of change is present within the predefined area from and closest to the point at the distance L₂ from the node N₁, i.e., map lane structure information 30b whose point of change is the point at the distance L₃ from the node N₁.

As a result, at step S110, the control part 20 determines that lane structures do not match each other, and accumulates, at step S120 and S125, pieces of image lane structure information 30c as candidates. Therefore, when the vehicle has traveled the same road a plurality of times and the statistical reliability of existing candidates has satisfied the criterion, the control part 20 performs step S135 after step S130. Then, when a difference between the number of lanes indicated by the map lane structure information 30b and the number of lanes indicated by the image lane structure information 30c exceeds the criterion, without making a determination for other elements, all elements are determined to serve as an update target.

As a result, at step S140, the control part 20 identifies the modes of the point of change and lane widths and the modal number of lanes, border types, and border colors from the pieces of image lane structure information 30c which are the existing candidates, and updates the point of change indicated by the map lane structure information 30b based on those pieces of information. FIG. 4B shows map lane structure information 30b after being updated based on the image lane structure information 30c. Namely, as shown in FIG. 4B, in the map lane structure information 30b after update, information indicating a lane structure is updated in all elements.

### (3) Other Embodiments

The above-described embodiment is an example for carrying out the disclosure, and other various embodiments can also be adopted as long as map information indicating a lane structure of a road is updated with an image lane structure when the image lane structure does not match a map lane structure. For example, the map information updating system may be implemented by a device other than the navigation system 10, a server that can communicate with the navigation system, etc. In addition, the map information updating system may be a device mounted on the vehicle, etc., or may be a device implemented by a portable terminal, or may be a system implemented by a plurality of devices (e.g., a client and a server).

In addition, at least some of the image lane structure obtaining part 21a, the map lane structure obtaining part 21b, and the map information updating part 21c may be separately present in a plurality of devices. For example, a configuration may be adopted in which the navigation system transmits an image lane structure to a server through communication, and the server compares a map lane structure with the image lane structure and updates the map lane structure. In this configuration, it is preferred that map lane structure information 30b after update be delivered to the vehicle. Of course, a part of the configuration of the above-described embodiment may be omitted or the processing order may be changed or omitted.

Furthermore, the map information updating system may update a map that is used for applications other than navigation. For example, a self-driving system that performs self-driving creates a target track for self-driving by referring to map information. Hence, as a system that updates the map information, the map information updating system may be used.

The image lane structure obtaining part may be configured in any manner as long as the image lane structure obtaining part can obtain an image lane structure which is a lane structure of a road on which the vehicle is present, based on an image of an area around the vehicle. Namely, when an image of an area around the vehicle includes an image of lanes, the fact that lanes are actually present around the vehicle can be identified. Therefore, by extracting the image of lanes from the image, a lane structure of the lanes present around the vehicle is obtained and can be used as an image lane structure.

Images may be obtained by various devices, and a camera is not limited to one whose field of view includes an area in front of the vehicle such as the one described above. For example, a camera whose field of view includes an area behind the vehicle may be used, or a camera whose field of view includes an area on a side of the vehicle may be used, or a camera whose field of view includes areas in all directions may be used, or a plurality of cameras may be used.

A lane structure may be any information about lanes indicated by map information, and various definitions other than the definitions in the above-described embodiment may also be adopted. For example, some of the elements of a lane structure in the above-described embodiment may be omitted, or other elements may be added. In addition, the lane structure may change depending on the application of map information. The other elements include restrictions on lanes, etc. There are various examples of the restrictions, and whether or not a lane change is allowed, a direction in which the vehicle can exit from an intersection for each lane, a speed limit, etc., may form a part of the lane structure. Note that since whether or not a lane change is allowed can be indicated by a lane border, the types of lane borders can also be considered as a type of restrictions.

The map lane structure obtaining part may be configured in any manner as long as the map lane structure obtaining part can obtain a map lane structure which is a lane structure of a road indicated by map information. Namely, the map lane structure obtaining part may be configured in any manner as long as map information is defined in advance before the vehicle travels an update-target road and the map lane structure obtaining part can obtain the map information. The map information may be used for various applications, and may be defined in various ways. For example, when a route search is performed, the map information is map information having a data structure (nodes and links) for searching for a route as in the above-described embodiment, and the map information has lane structures added thereto. In addition, for example, when the map information is map information used for self-driving, the map information can be configured to include more detailed locations of roads and intersections. Elements included in a map lane structure and elements included in an image lane structure may all match each other or may partly match each other.

The map information updating part may be configured in any manner as long as the map information updating part can determine whether an image lane structure matches a map lane structure and update, when the structures do not match each other, map information indicating a lane structure of a road with the image lane structure. Namely, the map information updating part may be configured in any manner as long as the map information updating part can estimate that, when an image lane structure that is identified by actual measurement using an image does not match a map lane structure, the image lane structure is correct and the map lane structure is incorrect, and update map information with the image lane structure.

Note that a determination as to whether an image lane structure matches a map lane structure may be performed by various techniques. For example, when at least one type of a plurality of elements indicating a lane structure is changed, it may be determined that an image lane structure does not match a map lane structure, or when a plurality of types of elements are changed, it may be determined that an image lane structure does not match a map lane structure.

At step S130, statistical reliability may be identified by various techniques. For example, it is possible to adopt a configuration in which a point of change or the like of an image lane structure is obtained a plurality of times, and when the standard deviation or variance of the point of change is less than or equal to a threshold value, it is determined that the statistical reliability satisfies the criterion. In addition, the statistic of the point of change used upon updating map information is not limited to the mode and may be the mean, median, etc.

Furthermore, a technique for updating map information indicating a lane structure of a road with an image lane structure when the image lane structure does not match a map lane structure as in the disclosure can also be applied as a program or a method. In addition, it can be assumed that the system, program, or method such as that described above is implemented as a single device or implemented by a plurality of devices, and includes various modes. For example, it is possible to provide a navigation system, a method, or a program that includes means such as those described above. In addition, changes can be made as appropriate, e.g., a part is software and a part is hardware. Furthermore, implementation is also feasible as a recording medium for a program that controls the system. Of course, the recording medium for software may be a magnetic recording medium or may be a semiconductor memory, and any recording medium to be developed in the future can also be considered exactly in the same manner.

### REFERENCE SIGNS LIST

10: Navigation system, 20: Control part, 21: Map information updating program, 21a: Image lane structure obtaining part, 21b: Map lane structure obtaining part, 21c: Map information updating part, 30: Recording medium, 30a: Map information, 30b: Map lane structure information, 30c: Image lane structure, 30c: Image lane structure information, 41: GNSS receiving part, 42: Vehicle speed sensor, 43: Gyro sensor, 44: Camera, and 45: User I/F part

1. A map information updating system comprising:
an image lane structure obtaining part that obtains an image lane structure based on an image of an area around a vehicle, the image lane structure being a lane structure of a road on which the vehicle is present;
a map lane structure obtaining part that obtains a map lane structure, the map lane structure being a lane structure of the road indicated by map information; and
a map information updating part that determines whether the image lane structure matches the map lane structure, and updates the map information with the image lane structure when the image lane structure does not match the map lane structure, the map information indicating the lane structure of the road.

2. The map information updating system according to claim 1, wherein the image lane structure is a lane structure around the vehicle identified by obtaining features of lane borders by analyzing the image obtained from a camera.

3. The map information updating system according to claim 1, wherein the update to the map information is an update to change a lane structure in front of a point of change at which a lane structure changes, from a lane structure indicated by the map lane structure to a lane structure indicated by the image lane structure.

4. The map information updating system according to claim 1, wherein a determination as to whether the image lane structure matches the map lane structure is made based on whether a plurality of elements indicating a lane structure match.

5. The map information updating system according to claim 4, wherein the plurality of elements include at least one of a point of change at which a lane structure changes, a number of lanes on the road, types of lane borders on the road, colors of lane borders on the road, widths of lanes on the road, and a restriction for each lane on the road.

6. The map information updating system according to claim 5, wherein
the update to the map information performed when it is determined that a number of lanes on the road indicated by the image lane structure does not match a number of lanes on the road indicated by the map lane structure is an update to change a lane structure in front of a point of change at which a lane structure changes,
from a number of lanes on the road, types of lane borders on the road, and colors of lane borders on the road indicated by the map lane structure
to a number of lanes on the road, types of lane borders on the road, and colors of lane borders on the road indicated by the image lane structure.

7. The map information updating system according to claim 1, wherein the update to the map information is performed when a difference between the image lane structure and the map lane structure exceeds a criterion.

8. A non-transitory computer-readable medium storing a map information updating program causing a computer to function as:
an image lane structure obtaining part that obtains an image lane structure based on an image of an area around a vehicle, the image lane structure being a lane structure of a road on which the vehicle is present;
a map lane structure obtaining part that obtains a map lane structure, the map lane structure being a lane structure of the road indicated by map information; and
a map information updating part that determines whether the image lane structure matches the map lane structure, and updates the map information with the image lane structure when the image lane structure does not match the map lane structure, the map information indicating the lane structure of the road.
